(19) United States
(12) Patent Application Publication
(10) Pub. No.: US 2004/0240552 A1
(43) Pub. Date: Dec. 2, 2004

(54) Moving picture processing apparatus

(76) Inventors: Hirotomo Sai, Yokohama (JP); Takuya Iguchi, Yamato (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/834,847

(22) Filed: Apr. 30, 2004

(30) Foreign Application Priority Data
May 30, 2003 (JP) 2003-155189

(51) Int. Cl. H04N 7/12

(52) U.S. Cl. 375/240.16; 375/240.26; 375/240.01; 375/240.12

(57) ABSTRACT

Disclosed herein is a A video data recording technique s capable of compressing/encoding video data in real time without deterioration in the playback image quality. Mixed video data into which a plurality of pieces of video data are time-divisionally combined is stored in a memory. According to the number of frames or fields of each video data, each video data is successively selected and read out from the memory and compressed/encoded based on the compress/encode information concerning a first compressing/encoding operation on the video data.

### BACKGROUND OF THE INVENTION

The present invention relates to a technique for compressing/encoding and recording a plurality of video data.

Techniques relating in general to the subject of the present invention are disclosed in Japanese Patent Laid-Open No. 10-276365 and Japanese Patent Laid-Open No. 9-93537. Japanese Patent Laid-Open No. 10-276365 describes a configuration to efficiently compress a plurality of pieces of video data by predictive encoding, wherein a plurality of pieces of input video data are time-divisionally combined into mixed video data, the mixed video data is stored in a plurality of memories in such a manner that each memory stores video data from a specific input terminal, a predetermined number of frames of video data are continuously read out from each memory, and inter-frame predictive encoding is performed on them through an MPEG encoding circuit. To efficiently encode a digital video signal at a variable rate without causing the image quality to deteriorate, described in Japanese Patent Laid-Open No. 9-93537 discloses a configuration comprising a unit to encode the input signal at a fixed quantizing level, a unit to record the generated information quantity in GOPs (Group Of Pictures), a unit to determine a target information quantity for the digital video signal by using the generated information quantity recorded, and a unit to control the code quantity according to the determined target information quantity.

### SUMMARY OF THE INVENTION

In the technique described in Japanese Patent Laid-Open No. 10-276365, video data from a plurality of cameras are combined into one mixed video data by switching the input camera on an individual frame basis. Inter-frame predictive encoding is performed on plural frames from the same camera, which frames are continuously read out. However, this inter-frame predictive encoding causes deterioration in the playback image quality, since it is difficult to judge in advance whether these frames constitute a greatly moving scene. Also, in the case of the technique described in Japanese Patent Laid-Open No. 9-93537, if the technique is applied to such systems as a real-time recording monitor camera system, a large capacity recording medium is further required to record mixed video data without compression. This may lead to an enlarged system scale.

In view of the situation created by these techniques, the present invention intends to make it possible to compress/encode and record mixed video data in real time without requiring a larger system and without deterioration of the playback image quality.

It is an object of the present invention to provide a technique that is capable of solving the above-described problems.

To solve the above-mentioned problems, the present invention provides a video data recording technique/configuration characterized in that: mixed video data, into which a plurality of video data are time-divisionally combined, is stored in a memory; according to the number of frames or fields of each video data, each video data is successively selected and read out from the memory; and the selected video data is successively compressed/encoded based on compress/encode information concerning a first compressing/encoding operation on the selected video data. More specifically, the present invention proposes a video data recording apparatus that is configured in such a manner and a video data recording method comprising such steps as repeated basic operations.

### BRIEF DESCRIPTION OF THE DRAWINGS

These and other features, objects and advantages of the present invention will become more apparent from the following description when taken in conjunction with the accompanying drawings wherein:

FIG. 1 is a block diagram which shows an example of the configuration of a video data recording apparatus representing an embodiment of the present invention;

FIG. 2 is a diagram which illustrates how mixed video data is stored in a memory and read out therefrom in the apparatus of FIG. 1; and

FIG. 3 is a diagram showing the configuration of the mixed video data input to the memory and read out therefrom in the apparatus of FIG. 1.

### DETAILED DESCRIPTION OF THE PREFERRED EMBODIMENTS

The description of an embodiment of the present invention will be presented with reference to the drawings.

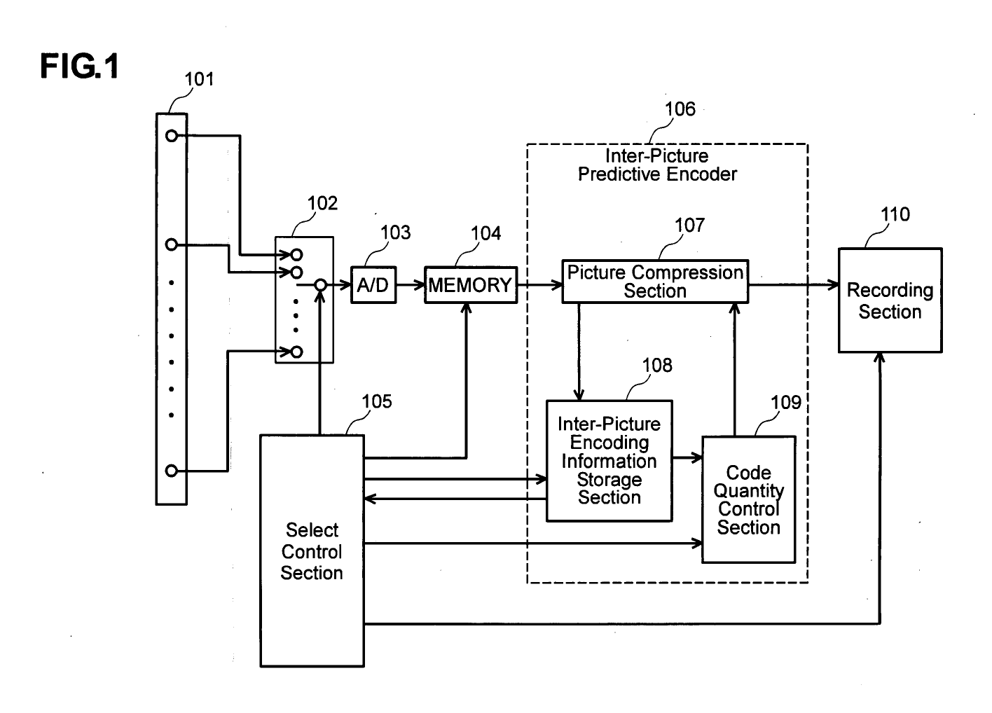

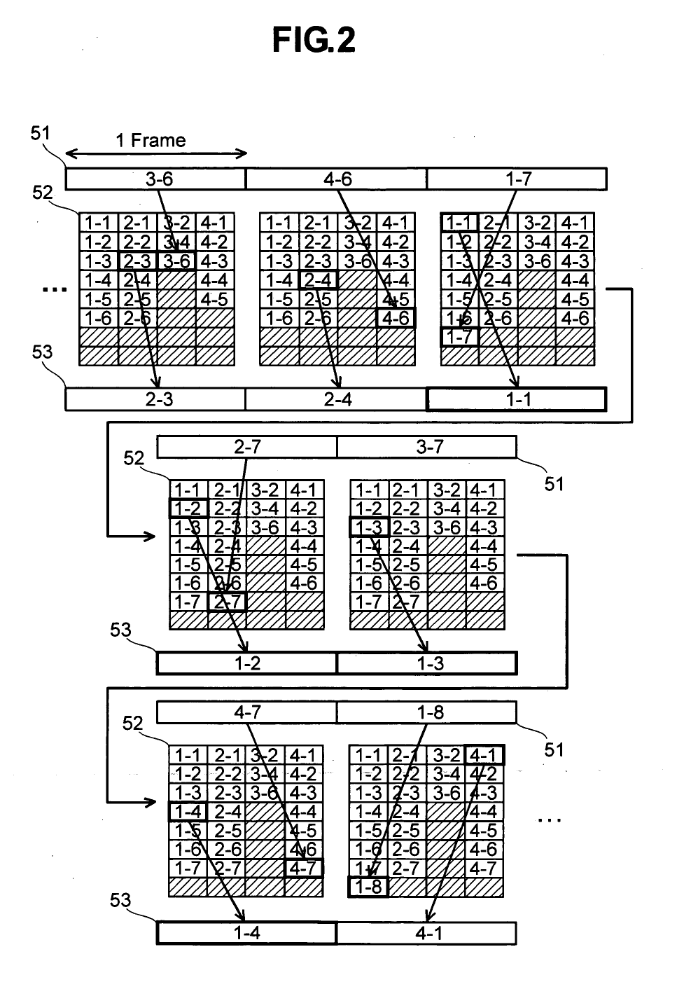

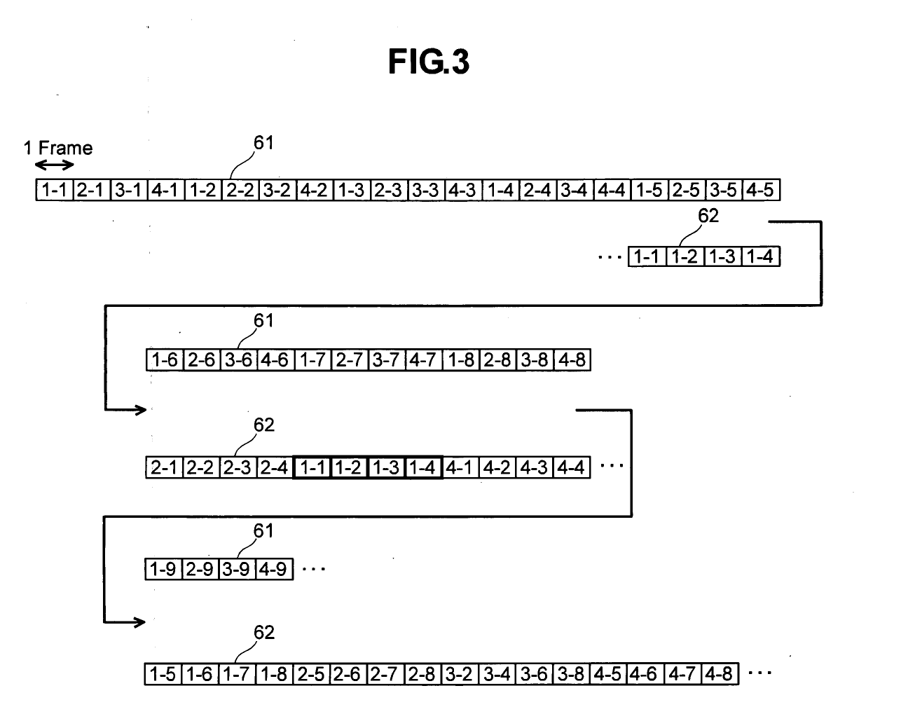

FIG. 1 through FIG. 3 illustrate an embodiment of the present invention. This embodiment is an example of a video data recording apparatus where video data from a plurality of cameras are encoded using inter-picture prediction and are recorded. FIG. 1 shows an example of a configuration of the video data recording apparatus representing an embodiment of the present invention. FIG. 2 is a diagram illustrating how mixed video data are held in a memory and read out therefrom in the apparatus of FIG. 1. FIG. 3 is a diagram showing the configuration of the mixed video data which is entered into a memory and the mixed video data which is read out from the memory.

In FIG. 1, the video data recording apparatus includes an input section 101, which serves as means to input a plurality of video data; switcher 102 by which video data output from the input section 101 are selected by rotation on a one frame per turn basis; a digital A/D conversion section 103 by which the output from the switcher 102 is converted to a digital picture signal; a memory 104 composed of a FIFO or the like; a select control section 105, which serves as control means to control the switching operation of the switcher 102 and, in conjunction with this switching control, to specify read/write regions in the memory 104; an inter-picture predictive encoder 106, which serves as encoding means by which mixed video data read out from the memory 104 is compressed and encoded; and a recording section 110 where the compressed and encoded video data is recorded on a recording medium, such as an optical disk. The inter-picture predictive encoder 106 includes a picture compression section 107, which compresses and encodes the video data read out from the memory 104; an inter-picture encode information storage section 108 where information (encode information) about the data generated through compression encoding by the picture compression section 107 is stored; and a code quantity control section 109, which controls the quantity of code based on the encode information stored in the inter-picture encode information storage section 108.

From the switcher 102, each video data is output intermittently (one frame every n frames). In the memory 104, these frame pictures are accumulated in the order of reception. Frame pictures, written (stored) in the memory 104, are read out on each video data basis. Each frame or field of video data is individually controlled by the code quantity control section 109.

FIG. 2 is a diagram which will be used to explain the operation of the select control section 105 in FIG. 1. It also illustrates how mixed video data is written to and read from the memory 104 as located by the select control section 105.

In FIG. 2, reference numeral 51 denotes mixed video data that is entered into the memory 104. It is a mixture derived from four pieces of video data. In the figure, each frame is labeled in the form of m-n, namely 1-1, 1-2, 1-3 . . . , 2-1, 2-2, 2-3 . . . , 3-2, 3-4, 3-6, 4-1, 4-2, 4-3 . . . , wherein “m” is one of the numbers (m=1, 2, 3, 4) given respectively as labels to the video data while “n” is one of the time-series numbers which are respectively given to frames of each video data. That is, 1-1 represents frame 1 of video data 1. In this example shown in the figure, video data 1, video data 2, video data 4 are recorded at a rate of 1 frame every 4 frames, whereas video data 3 is recorded at a rate of one frame every eight frames. Reference numeral 52 schematically shows how the content of the memory 104 changes with time. Reference numeral 53 denotes mixed video data read out from the memory 104 at a rate of four frames of the same video data per read. Of the memory content 52, each box represents one storage region to store one frame. Each box highlighted by a thick line represents a region from or to which a read or write operation is being carried out at that time. Each arrow indicates a read or write operation. In each hatched box, there is a frame stored earlier than frame 1 of the video data. Of the video data 53 read out from the memory 104, note that frames 1-1, 1-2, 1-3 and 1-4, highlighted, are output as video data. This is because video data 3 (video data labeled “3”) is recorded at a half rate. If video data 3 is recorded at a rate of one frame every four frames, frames 3-1, 3-2, 3-3 and 3-4 would appear there. Read from and write (storage) to the memory 104 are controlled by the select control section 105 so as to rearrange the mixed video data in this manner.

FIG. 3 is a diagram which shows the mixed video data input to the memory and the mixed video data read out from the memory in the apparatus of FIG. 1.

In FIG. 3, reference numeral 61 denotes frames labeled 1-1, . . . , 4-9 of the mixed video data to be written into the memory 104. Reference numeral 62 denotes frames labeled 1-2, . . . , 4-8 of the mixed video data to be read out from the memory 104. A highlighted part of the mixed video data 62 to be read out from the memory 104 is a time slot in which a sequence of four frames 1-1, 1-2, 1-3 and 1-4 of video data 1 are read out from the memory 104 once again. This time slot is generated by lowering the recording frame rate of video data. In such a time slot, the select control section 105 reads out a sequence of plural frames of one video data once again from the memory 104. In FIG. 3, a sequence of four frames of any video data, namely 1-1, . . . , 1-4, 2-1, . . . , 2-4 or 4-1, . . . , 4-4 may be selected and output. A sequence of four frames of video data labeled 3, written before frame 3-1, may also be selected and output.

In FIG. 2 and FIG. 3, a time slot for selecting and outputting the same sequence of plural frames of video data once again is secured by lowering the number of frames recorded per unit time of video data. This time slot may also be secured by, for example, reducing the number of video data included in the mixed video data.

The following description concerns the operation of the inter-picture predictive encoder 106 in FIG. 1.

The video data read out from the memory 104 is supplied to the picture compression section 107 in which the video data is compressed/encoded (converted) by such an encoding method as MPEG. The encoded data from the picture compression section 107 is recorded on a recording medium in the recording section 110. Encode information about the compressing/encoding operation of the picture compression section 107 is stored in the inter-picture encode information storage section 108. The stored encode information includes per-frame generated code quantities, set target code quantities, and motion vector quantities. The inter-picture encode information storage section 108 supplies encode information to the code quantity control section 109. The select control section 105 specifies which video data is to be concerned by the encode information. If the frames read out from the memory 104 are not the first sequence of plural frames of the video data, the code quantity control section 109 sets a target code quantity to the picture compression section 107 according to the previous code quantity and target code quantity. If the previous code quantity is larger than the target code quantity, the target code quantity is controlled so as to reduce the quantity of code to be generated by the picture compression section 107. If the previous code quantity is smaller than the target code quantity, the target code quantity is controlled so as to increase the quantity of code to be generated by the picture compression section 107.

If the frames read out from the memory 104 are the second or subsequent sequence of plural frames of the video data, the code quantity control section 109 sets the target code quantity on an each frame sequence basis so that the quantity of encoded data to be generated by the picture compression section 107 is controlled as targeted. The target code quantity per frame is also controlled according to the inter-frame differences among the frames in such a manner that the target code quantity is increased if the frames contain large vector quantities or large/fast motions and is decreased if the frames do not contain such motions.

The following description indicates how the select control section 105 determines which video data is to be output redundantly from the memory 104. The select control section 105 compares the video data according to per-frame code quantities, set target code quantities and motion vectors recorded in the encode information storage section 108. If there are relatively higher differences between the generated code quantities and set target code quantities recorded for one video data, this video data is given a higher priority. From the video data which can be output redundantly, the highest priority video data is selected. For example, assume that of the four pieces of video data 1, 2, 3 and 4 in FIG. 2, video data 1 is given the highest priority, followed by video 2, video 3 and video 4 in this order. In this case, the highest priority video data 1 is selected, with the result that its frame sequence 1-1, . . . , 1-4 is output more than once. Note that it is also possible for the user to give a fixed priority level to each video data.

The video data encoded by the inter-picture predictive encoder 106 is sequentially recorded on a recording medium, such as an optical disk, in the recording section 110. If a sequence of plural frames of video data is encoded more than once by the select control section 105, only the data generated by the last encoding is recorded.

The video data recording apparatus operates as described so far with reference to FIG. 1 through FIG. 3. Its operations are implemented by a computer, for example, a microcomputer in the apparatus, according to a program set up in advance. This program is stored in the video data recording apparatus.

According to the embodiment described so far, mixed video data can be compressed/encoded and recorded in real time by a smaller system without deterioration of the playback picture quality.

Although inter-frame predictive encoding is performed in the embodiment, the present invention is not limited to such an application. For example, the embodiment can be modified so as to perform inter-field predictive encoding with substantially the same configuration.

According to the present invention, it is possible to compress/encode mixed video data in real time without degeneration of the quality of the playback pictures.

While we have shown and described several embodiments in accordance with our invention, it should be understood that the disclosed embodiments are susceptible of changes and modifications without departing from the scope of the invention. Therefore, we do not intend to be bound by the details shown and described herein, but intend to cover all such changes and modifications as fall within the ambit of the appended claims.

1. A video data recording apparatus in which mixed video data, which includes a plurality of pieces of video data, is compressed/encoded and recorded, comprising:
a memory to store input mixed video data;
a control module which controls the memory so that, according to the number of frames or fields of each video data, each video data is successively selected and read out from the memory;
an encoding module which successively compresses/encodes the selected video data based on compress/encode information concerning a first compressing/encoding operation on the selected video data; and
a recording section to record the compressed/encoded video data.

2. A video data recording apparatus in which digital mixed video data, which includes a plurality of pieces of video data, is compressed/encoded and recorded, comprising:
an input section to input a plurality of pieces of video data;
a switching module to combine the plurality of pieces of video data into mixed video data by selecting the plurality of pieces of video data in turn either in frames or in fields;
a memory to store the mixed video data either in frames or in fields;
a control module which controls the memory so that according to the amount of video data in the mixed video data and the number of frames or fields of each video data, each sequence of plural frames or fields of each video data is successively selected and read out from the memory;
an encoding module which controls a coding quantity in successively compressing/encoding the selected video data based on compress/encode information concerning a first compressing/encoding operation on the selected video data; and
a recording section to record the compressed/encoded video data.

3. The video data recording apparatus according to claim 1 or 2, wherein the encoding module is configured such that set target code quantities, code quantities after compressed/encoded and inter-frame or inter-field motion vectors can be stored.

4. The video data recording apparatus according to claim 1 or 2, wherein the encoding module sets a target code quantity for the video data so as to increase the code quantity if the motion vectors to be compressed/encoded are larger than those included in said compress/encode information and decrease the code quantity if the motion vectors are smaller.

5. The video data recording apparatus according to claim 1 or 2, wherein the control module prioritizes the plurality of pieces of video data and controls the memory so that plural frames or fields of some high priority video data are redundantly read out.

6. The video data recording apparatus according to claim 4, wherein the control module controls the memory so that plural frames or fields of some video data which causes large differences between target code quantities and corresponding code quantities after encoded and has large inter-frame or inter-field vectors are redundantly read out.

7. A video data recording method for compressing/encoding and recording digital mixed video data, which includes a plurality of pieces of video data, said method comprising:
a first step of inputting a plurality of pieces of video data;
a second step of combining the plurality of video data into mixed video data by selecting the plurality of video data in turn either in frames or in fields;
a third step of storing the mixed video data either in frames or in fields;
a fourth step of, according to the amount of coding quantities of video data in the mixed video data and the number of frames or fields of each video data, successively selecting and reading out each sequence of plural frames or fields of each video data from the memory;
a fifth step of controlling a coding quantity in successively compressing/encoding the selected video data based on compress/encode information concerning a first compressing/encoding operation on the selected video data; and
a sixth step of recording the compressed/encoded video data.

8. The video data recording method according to claim 7, wherein, in the fifth step, a target code quantity is set for the video data so as to increase the code quantity if the motion vectors to be compressed/encoded are larger than those included in said compress/encode information and to decrease the code quantity if the motion vectors are smaller.

9. The video data recording method according to claim 7, wherein in the fourth step, the plurality of video data are prioritized and plural frames or fields of some high priority video data are redundantly read out.

10. A video data recording control program to compress/encode and record mixed video data including a plurality of pieces of video data, which runs a computer so as to execute the procedures of:
storing the input mixed video data;
according to the number of frames or fields of each video data, successively selecting and reading out each sequence of plural frames or fields of each video data from a memory;
successively compressing/encoding the selected video data based on the compress/encode information concerning a first compressing/encoding operation on the selected video data; and
recording the compressed/encoded video data.
